(19) United States
(12) Patent Application Publication
(10) Pub. No.: US 2008/0098930 A1
(43) Pub. Date: May 1, 2008

(54) COLORANT DISPERSANT

(75) Inventors: Raymond W. WONG, Mississauga (CA); Bo WU, Wilsonville, OR (US); Everett NESS, Lake Oswego, OR (US); Caroline M. TUREK, Hamilton (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/555,405

(22) Filed: Nov. 1, 2006

(51) Int. Cl. C09D 11/00

(52) U.S. Cl. 106/31.29; 106/31.61; 106/31.43; 106/31.75; 106/31.73; 106/31.41

(57) ABSTRACT

A phase change ink having an ink vehicle, at least one colorant and dispersants, such as at least one polyalkylene succinimide, at least one triamide and/or at least one rosin ester. The dispersants assist in dispersing colorants, such as pigments like carbon black, in non-polar ink vehicles. Also, disclosed are methods of making such phase change inks.

### BACKGROUND

Described herein are inks such as solid phase change or hot melt inks that have a colorant, such as a pigment, substantially evenly dispersed throughout the non-polar ink vehicle, the ink including therein polyalkylene succinimide, and triamide and/or rosin ester as dispersants. Also, disclosed are methods of making such phase change inks.

The phase change ink compositions illustrated herein in embodiments are solid at room temperature, for example from about 20° C. to about 27° C., and are suitable for ink jet printing processes, particularly piezoelectric and acoustic ink jet printing processes.

### REFERENCES

Ink jetting devices are known in the art. As described in U.S. Pat. No. 6,547,380, the disclosure of which is totally incorporated herein by reference, ink jet printing systems are generally of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium. There are generally three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (that is, liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device, the image is applied by jetting appropriately colored inks during four to eighteen rotations (incremental movements) of a substrate such as an image receiving member or intermediate transfer member with respect to the ink jetting head, that is, there is a small translation of the printhead with respect to the substrate in between each rotation. This approach simplifies the printhead design, and the small movements ensure good droplet registration. At the jet operating temperature, droplets of liquid ink are ejected from the printing device. When the ink droplets contact the surface of the recording substrate, either directly or via an intermediate heated transfer belt or drum, they quickly solidify, to form a predetermined pattern of solidified ink drops. Phase change ink jet processes are well known.

Ink jet printing processes may employ inks that are solid at room temperature and liquid at elevated temperatures. Such inks may be referred to as hot melt inks or phase change inks. For example, U.S. Pat. No. 4,490,731, the disclosure of which is totally incorporated herein by reference, discloses an apparatus for dispensing solid ink for printing on a substrate such as paper.

In thermal ink jet printing processes employing hot melt inks, the solid ink is melted by the heater in the printing apparatus and utilized (that is, jetted) as a liquid in a manner similar to that of conventional thermal ink jet printing. Upon contact with the printing substrate, the molten ink solidifies rapidly, enabling the colorant to substantially remain on the surface of the substrate instead of being carried into the substrate (for examples paper) by capillary action, thereby enabling higher print density than is generally obtained with liquid inks. Advantages of a phase change ink in ink jet printing thus include elimination of potential spillage of the ink during handling, a wide range of print density and quality, minimal paper cockle or distortion, and enablement of indefinite periods of nonprinting without the danger of nozzle clogging, even without capping the nozzles.

U.S. Pat. Nos. 5,006,170 and 5,122,187, the disclosures of each of which are totally incorporated herein by reference, disclose hot melt ink compositions suitable for ink jet printing which comprise a colorant, a binder, and a propellant.

U.S. Pat. No. 4,889,560, the disclosure of which is totally incorporated herein by reference, discloses a phase change ink carrier composition combined with a colorant to form a phase change ink composition.

While the references described herein are suitable for their intended uses, improvements are still desired. Materials described in the above mentioned references may be used herein, as appropriate.

Phase change inks used in inkjet printing apparatuses have a number of advantages ranging from vibrant colors and expansive color gamut. It is still desired to produce a phase change ink having a colorant, such as a pigment, substantially evenly dispersed throughout the entire ink vehicle. It is particularly desired to produce phase change inks that have high stability at increased temperatures.

### SUMMARY

In embodiments, disclosed herein is a phase change ink comprising an ink vehicle, at least one colorant, at least one polyalkylene succinimide, and at least one triamide and/or at least one rosin ester.

In further embodiments, disclosed is a method of forming an ink, comprising preparing an ink vehicle in a first container by mixing the ink vehicle at a temperature of from about 90° C. to about 150° C., preparing a colorant dispersion mixture in a second container by mixing at least one polyalkylene succinimide, and at least one triamide and/or at least one rosin ester, and at least one colorant, homogenizing the mixture in the second container at a temperature of from about 90° C. to about 150° C., introducing the ink vehicle from the first container into the homogenized mixture of the second container and further homogenized and melt mixed with other ink ingredients to form an ink, and allowing the ink to cool to about room temperature to form a phase change ink. The colorant dispersion mixture can be optionally pre-treated through an extruder before the melt mixing and homogenization step in the second container.

In yet further embodiments, disclosed is an ink jet system, comprising at least one phase change ink having an ink vehicle, at least one colorant, at least one polyalkylene succinimide, and at least one triamide and/or at least one rosin ester, and an ink jet device including an ink jet head consisting of one or more channels for the at least one phase change ink, and a supply path that supplies the at least one phase change ink to the one or more channels of the ink jet head from one or more reservoirs containing the at least one phase change ink.

### EMBODIMENTS

The phase change inks include an ink vehicle that is solid at room temperature, for example temperatures of about 20° C. to about 27° C., and specifically are solid at temperatures below about 40° C. However, the inks change phase upon heating, and are in a molten state at jetting temperatures, so that the inks have a viscosity of from about 1 to about 20 centipoise (cP), such as from about 5 to about 15 cP or from about 8 to about 12 cP, at an elevated temperature suitable for ink jet printing, such as temperatures of from about 50° C. to about 150° C.

In this regard, the inks herein may be low energy inks. Low energy inks are solid at a temperature below about 40° C. and have a viscosity of from about 5 to about 15 cP at a jetting temperature of from about 50° C. to about 150° C., such as from about 70° C. to about 130° C. or from about 80° C. to about 120° C. The inks jet at lower temperatures, and thus require lower amounts of energy for jetting.

Any suitable ink vehicle can be employed. Suitable vehicles include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below, and mixtures thereof.

Examples of suitable ink vehicles include polyethylene waxes having weight average molecular weights less than 1500, such as less than 1250 or less than 1000. Such ink vehicles may be major components in mainline high melting and low melting solid inks, respectively. These wax materials have low melting points that allow for low jetting temperatures to be utilized and maintained while also lowering the coefficient of friction of the ink.

Polyalkylene waxes, such as POLYWAX 655 and 500 (Baker-Petrolite Corp.), having a carbon chain length of from about 30 carbon atoms to about 70 carbon atoms (POLY WAX 500) or from about 30 carbon atoms to about 100 carbon atoms (POLYWAX 655). This polyethylene wax may have an average peak molecular weight, as measured by high temperature gel permeation chromatography, of from about 350 to about 730, such as from about 400 to about 700 or from about 470 to about 600.

Examples of other suitable ink vehicles include, for example, ethylene/propylene copolymers, such as those available from Petrolite and of the general formula

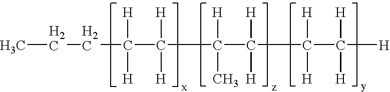

wherein z represents an integer from 0 to about 30, for example from 0 to about 20 or from 0 to about 10, y represents an integer from 0 to about 30, for example from 0 to about 20 or from 0 to about 10 and x is equal to about 21-y. The distribution of the side branches may be random along the carbon chain. The copolymers may have, for example, a melting point of from about 70° C. to about 150° C., such as from about 80° C. to about 130° C. or from about 90° C. to about 120° C. and a molecular weight range of from about 500 to about 4,000. Commercial examples of such copolymers include, for example, Petrolite CP-7 (Mn=650), Petrolite CP-11 (Mn=1,100, Petrolite CP-12 (Mn=1,200) and the like.

Another type of ink vehicle may be n-paraffinic, branched paraffinic, and/or aromatic hydrocarbons, typically with from about 5 to about 100, such as from about 20 to about 180 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Petrolite.

Highly branched hydrocarbons, typically prepared by olefin polymerization, such as the VYBAR materials available from Petrolite, including VYBAR 253 (Mn=520), VYBAR 5013 (Mn=420), and the like, may also be used. In addition, the ink vehicle may be an ethoxylated alcohol, such as available from Petrolite and of the general formula

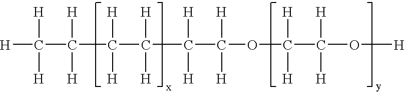

wherein x is an integer of from about 1 to about 50, such as from about 5 to about 40 or from about 11 to about 24 and y is an integer of from about 1 to about 70, such as from about 1 to about 50 or from about 1 to about 40. The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560), UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, mention may be made of fatty amides, such as monoamides, tetra-amides, mixtures thereof, and the like, for example such as described in U.S. Pat. No. 6,858,070, incorporated herein by reference. Suitable monoamides may have a melting point of at least about 50° C., for example from about 50° C. to about 150° C., although the melting point can be below this temperature. Specific examples of suitable monoamides include, for example, primary monoamides and secondary monoamides. Stearamide, such as KEMAMIDE S available from Witco Chemical Company and CRODAMIDE S available from Croda, behenamide/arachidamide, such as KEMAMIDE B available from Witco and CRODAMIDE BR available from Croda, oleamide, such as KEMAMIDE U available from Witco and CRODAMIDE OR available from Croda, technical grade oleamide, such as KEMAMIDE O available from Witco, CRODAMIDE O available from Croda, and UNISLIP 1753 available from Uniqema, and erucamide such as KEMAMIDE E available from Witco and CRODAMIDE ER available from Croda, are some examples of suitable primarily amides. Behenyl behenamide, such as KEMAMIDE EX666 available from Witco, stearyl stearamide, such as KEMAMIDE S-180 and KEMAMIDE EX-672 available from Witco, stearyl erucamide, such as KEMAMIDE E-180 available from Witco and CRODAMIDE 212 available from Croda, erucyl erucamide, such as KEMAMIDE E-221 available from Witco, oleyl palmitamide, such as KEMAMIDE P-181 available from Witco and CRODAMIDE 203 available from Croda, and erucyl stearamide, such as KEMAMIDE S-221 available from Witco, are some examples of suitable secondary amides. Additional suitable amide materials include KEMAMIDE W40 (N,N′-ethylenebisstearamide), KEMAMIDE P181 (oleyl palmitamide), KEMAMIDE W45 (N,N′-thylenebisstearamide), and KEMAMIDE W20 (N,N′-ethylenebisoleamide).

High molecular weight linear alcohols, such as those available from Petrolite and of the general formula

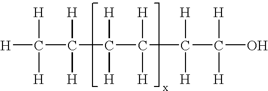

wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500. Commercial examples include the UNILIN materials such as UNILIN 425 (Mn=460), UNILIN 550 (Mn=550), UNILIN 700 (Mn=700), and the like.

A still further example includes hydrocarbon-based waxes, such as the homopolymers of polyethylene available from Petrolite and of the general formula

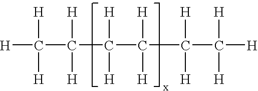

wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000. Example waxes include the line of waxes, such as POLYWAX 500 (Mn=500), POLYWAX 655 (Mn=655), POLYWAX 850 (Mn=850), POLYWAX 1000 (Mn=1,000), and the like.

Another example includes modified maleic anhydride hydrocarbon adducts of polyolefins prepared by graft copolymerization, such as those available from Petrolite and of the general formulas

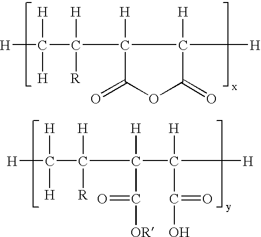

wherein R is an alkyl group with from about 1 to about 50, such as from about 5 to about 35 or from about 6 to about 28 carbon atoms, R′ is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C., such as from about 60° C. to about 120° C. or from about 70° C. to about 100° C.; those available from Petrolite and of the general formula

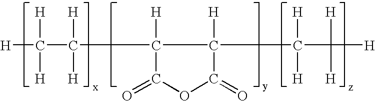

wherein x is an integer of from about 1 to about 50, such as from about 5 to about 25 or from about 9 to about 13, y is 1 or 2, and z is an integer of from about 1 to about 50, such as from about 5 to about 25 or from about 9 to about 13; and those available from Petrolite and of the general formula

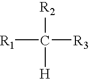

wherein R₁ and R₃ are hydrocarbon groups and R₂ is either of one of the general formulas

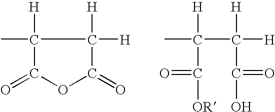

or a mixture thereof, wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn=700, Mw/Mn=1.7), and the like.

Yet other suitable carrier materials are isocyanate-derived resins and waxes, such as urethane isocyanate-derived materials, urea isocyanate-derived materials, urethane/urea isocyanate-derived materials, mixtures thereof, and the like. Further information on isocyanate-derived carrier materials is disclosed in, for example, U.S. Pat. No. 5,750,604, U.S. Pat. No. 5,780,528, U.S. Pat. No. 5,782,966, U.S. Pat. No. 5,783,658, U.S. Pat. No. 5,827,918, U.S. Pat. No. 5,830,942, U.S. Pat. No. 5,919,839, U.S. Pat. No. 6,255,432, U.S. Pat. No. 6,309,453, British Patent GB 2 294 939, British Patent GB 2 305 928, British Patent GB 2 305 670, British Patent GB 2 290 793, PCT Publication WO 94/14902, PCT Publication WO 97/12003, PCT Publication WO 97/13816, PCT Publication WO 96/14364, PCT. Publication WO 97/33943, and PCT Publication WO 95/04760, the disclosures of each of which are totally incorporated herein by reference.

Additional examples of suitable ink vehicles for the phase change inks include rosin esters, such as glyceryl abietate (KE-100®); polyamides; dimer acid amides; fatty acid amides, including ARAMID C; epoxy resins, such as EPOTUF 37001, available from Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX S552, available from Velsicol Chemical Company; phthalate plasticizers; citrate plasticizers; maleate plasticizers; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, montan wax, candelilla wax, GILSONITE (American Gilsonite Company), and the like; mixtures of linear primary alcohols with linear long chain amides or fatty acid amides, such as those with from about 6 to about 24 carbon atoms, including PARICIN 9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as diphenyl sulfone, n-aryl sulfone, n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, chlorophenyl methyl sulfone, and the like, are suitable ink vehicle materials.

In addition, the ink vehicles described in U.S. Pat. No. 6,906,118, incorporated herein by reference in its entirety, may also be used. Also suitable as ink vehicles are liquid crystalline materials as disclosed in, for example, U.S. Pat. No. 5,122,187, the disclosure of which is totally incorporated herein by reference.

The ink vehicle may comprise one or more of the aforementioned suitable vehicles. As used herein, “one or more” and “at least one” refers to from 1 to about 10, such as from 1 to about 8 or from 1 to about 5, of any given feature disclosed herein.

The ink vehicle may comprise from about 25% to about 99.5% by weight of the ink, for example from about 30% to about 90% or from about 50% to about 85% by weight of the ink.

The inks disclosed herein may contain any suitable colorant which may include at least one pigment. As used herein the term “colorant” includes pigments, dyes, mixtures of dyes, mixtures of pigments, mixtures of dyes and pigments, and the like.

Examples of suitable pigments include, for example, PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical 249-0592); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (Ciba); PALIOGEN Red 3871 K (BASF); SUNFAST® Blue 15:3 (Sun Chemical 249-1284); PALIOGEN Red 3340 (BASF); SUNFAST® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); SPECTRA PAC® C Orange 16 (Sun Chemical 276-3016); HELIOGEN Blue K6902, K6910 (BASF); SUNFAST® Magenta 122 (Sun Chemical 228-0013); HELIOGEN Blue D6840, D7080 (BASF); Sudan Blue OS (BASF); NEOPEN Blue FF4012 (BASF); PV Fast Blue BD2GO1 (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D1355, D1351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF).

Examples of black pigments include carbon black products from Cabot corporation, such as Black Pearls 2000, Black Pearls 1400, Black Pearls 1300, Black Pearls 1100, Black Pearls 1000, Black Pearls 900, Black Pearls 880, Black Pearls 800, Black Pearls 700, Black Pearls 570, Black Pearls 520, Black Pearls 490, Black Pearls 480, Black Pearls 470, Black Pearls 460, Black Pearls 450, Black Pearls 430, Black Pearls 420, Black Pearls 410, Black Pearls 280, Black Pearls 170, Black Pearls 160, Black Pearls 130, Black Pearls 120, Black Pearls L; Vulcan XC72, Vulcan PA90, Vulcan 9A32, Regal 660, Regal 400, Regal 330, Regal 350, Regal 250, Regal 991, Elftex pellets 115, Mogul L. Carbon black products from Degussa-Hüls such as FW1, Nipex 150, Printex 95, SB4, SB5, SB100, SB250, SB350, SB550; Carbon black products from Columbian such as Raven 5750; Carbon black products from Mitsubishi Chemical such as #25, #25B, #44, and MA-100-S can also be utilized.

Other suitable black pigments include FERRO™ 6330, a manganese ferrite pigment available from Ferro Corporation, and Paliotol Black 0080 (Aniline Black) available from BASF.

In embodiments, the colorant may be from about 0.5 weight percent to about 20 weight percent of the ink, such as from about 1 weight percent to about 8 weight percent or from about 1.5 weight percent to about 6 weight percent of the ink.

Colorants suitable for use herein include colorant particles having an average particle size of from about 10 nm to about 1000 nm, such as from about 25 nm to about 250 nm or from about 50 mm to about 150 nm.

In embodiments, colorants suitable for use herein may be black, such as carbon black. U.S. Pat. No. 6,878,198, which is incorporated herein by reference in its entirety, discloses a carbon black phase change ink that demonstrates high stability. However, it is still desired to produce phase change inks having a colorant, such as a pigment, that exhibit improved stability of ink exposed to high temperatures, such as from about 90° C. to about 150° C., which is the approximate temperature at which phase change inks are jetted, as described in detail below.

To suitably disperse the pigments in a phase change ink vehicle, a dispersant to stabilize the pigment particle to withstand elevated jetting temperatures and also be compatible with other ingredients in the ink formulation may be used. The term “stabilize” refers to, for example, the dispersant physically being bonded to or adsorbed to the surface of the pigment particle within the ink vehicle, by steric stabilization, by electric static stabilization, or a combination of both. The aim of stabilization is to keep the pigment particles separated, and to control the degree of pigment particle size. Dispersants suitable for use herein include a combination of at least one polyalkylene succinimide, together with at least one triamide and/or at least one rosin ester. “At least one” as used herein refers to, for example, from 1 to about 10, such as from 1 to about 7 or from 1 to about 5 of each of the triamide, the rosin ester and the polyalkylene succinimide.

Suitable polyalkylene succinimides include those having the following general formula:

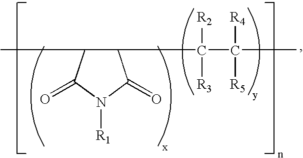

wherein x is an integer representing the number of repeat succinimide units and is from, for example, 1 to about 10, such as from 1 to about 5 or from 1 to about 3, y is an integer representing the number of repeat alkylene units and is from 1 to about 10, such as from 1 to about 5 or from 1 to about 3, n is an integer of at least about 2, such as from about 2 to about 150 or from about 10 to about 75; R₁ is an alkyl group (including linear, branched, cyclic, saturated, unsaturated, substituted, and unsubstituted alkyl groups, and wherein hetero atoms, such as oxygen, nitrogen, sulfur, silicon, phosphorus, and the like either may or may not be present in the alkyl group) having from about 1 carbon atom to about 100 carbon atoms, such as from about 1 carbon atom to about 50 carbon atoms or from about 5 carbon atoms to about 30 carbon atoms, an aryl group (including substituted and unsubstituted aryl groups, and wherein hetero atoms, such as oxygen, nitrogen, sulfur, silicon, phosphorus, and the like either may or may not be present in the aryl group), having from about 4 carbon atoms to about 100 carbon atoms, such as from about 5 carbon atom to about 50 carbon atoms or from about 6 carbon atoms to about 40 carbon atoms, an arylalkyl group (including substituted and unsubstituted arylalkyl groups, and wherein the alkyl portion thereof can be linear, branched, cyclic, saturated, or unsaturated, and wherein hetero atoms, such as oxygen, nitrogen, sulfur, silicon, phosphorus, and the like either may or may not be present in either or both of the aryl portion and the alkyl portion of the arylalkyl group), having from about 5 carbon atoms to about 100 carbon atoms, such as from about 6 carbon atom to about 50 carbon atoms or from about 7 carbon atoms to about 40 carbon atoms, in another embodiment with at least about 6 carbon atoms, and in yet another embodiment with at least about 7 carbon atoms, such as benzyl or the like, or an alkylaryl group (including substituted and unsubstituted alkylaryl groups, and wherein the alkyl portion thereof can be linear, branched, cyclic, saturated, or unsaturated, and wherein hetero atoms, such as oxygen, nitrogen, sulfur, silicon, phosphorus, and the like either may or may not be present in either or both of the aryl portion and the alkyl portion of the alkylaryl group), having from about 5 carbon atoms to about 100 carbon atoms, such as from about 6 carbon atom to about 50 carbon atoms or from about 7 carbon atoms to about 40 carbon atoms, such as tolyl or the like, and R₂, R₃, R₄, and R₅ may each independently be a hydrogen atom or an alkyl group (including linear, branched, cyclic, saturated, unsaturated, substituted, and unsubstituted alkyl groups, and wherein hetero atoms, such as oxygen, nitrogen, sulfur, silicon, phosphorus, and the like either may or may not be present in the alkyl group) having from about 1 carbon atom to about 40 carbon atoms, such as from about 3 carbon atoms to about 30 carbon atoms or from about 5 carbon atoms to about 20 carbon atoms, and wherein the substituents on the substituted alkyl, aryl, arylalkyl, and alkylaryl groups may be hydroxy groups, halogen atoms, amine groups, imine groups, ammonium groups, cyano groups, pyridine groups, pyridinium groups, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring. In embodiments, R₂, R₃, and R₄ may be hydrogen atoms and R₅ may be an alkyl group. IN yet further embodiments, R₂ and R₃ may be hydrogen atoms and R₄ and R₅ may be methyl groups.

Examples of suitable polyalkylene succinimides for use herein include polyisobutylene succinimide and the like. Examples of commercially available polyalkylene succinimides include the Chevron Oronite OLOA 11000, OLOA 11001, OLOA 11002, OLOA 11005, OLOA 371, OLOA 375, OLOA 411, OLOA 4500, OLOA 4600, OLOA 8800, OLOA 8900, OLOA 9000, OLOA 9100, OLOA 9200, and the like, available from Chevron Oronite Company LLC, Houston, Tex., and the like, as well as mixtures thereof. Examples of suitable polyalkylene succinimides and their precursors and methods of making them are also disclosed in, for example, U.S. Pat. No. 3,172,892, U.S. Pat. No. 3,202,678, U.S. Pat. No. 3,280,034, U.S. Pat. No. 3,442,808, U.S. Pat. No. 3,361,673, U.S. Pat. No. 3,172,892, U.S. Pat. No. 3,912,764, U.S. Pat. No. 5,286,799, U.S. Pat. No. 5,319,030, U.S. Pat. No. 3,219,666, U.S. Pat. No. 3,381,022, U.S. Pat. No. 4,234,435, and European Patent Publication 0 776 963, the disclosures of each of which are totally incorporated herein by reference.

In embodiments, the polyalkylene succinimide may be present in the ink in any desired or effective amount, for example, from about 0.001 weight percent to about 40 weight percent of the ink, such as from about 0.005 weight percent to about 30 weight percent of the ink or from about 0.01 weight percent to about 20 weight percent of the ink. The effective amount of polyalkylene succinimide in the ink may vary depending on the physical and chemical characteristics of the pigment particles, such as aggregate size, surface area, density of functional groups on the particle surfaces, quality of the interaction between the pigment particles and the ink carrier or components thereof, and many other such considerations.

In embodiments, in addition to the polyakylene succinimide, the phase change ink may include at least one triamide and/or at least one rosin ester.

Triamides suitable for use herein include linear triamides, which are molecules where all three amide groups are drawn in the same molecular chain or branch. Examples of linear triamides include those triamides having the following formulas:

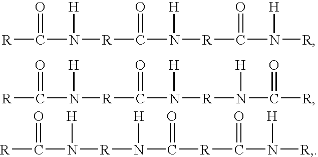

### Where R can be any hydrocarbon having from about 1 to about 200 carbon atoms, such as from about 25 to 150 carbon atoms or from about 30 to about 100 carbon atoms.

Linear triamides can further include those wherein a line can be drawn through the three amide groups, even if one would ordinarily draw a different line. One example of such a triamide can be expressed by the following formula:

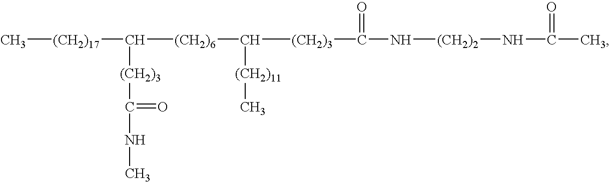

which can be drawn as:

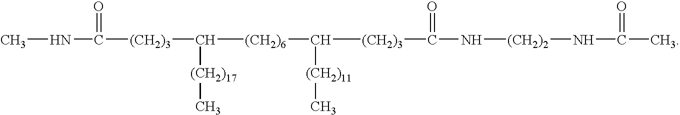

In embodiments, the triamide may also be a branched triamide. Examples of suitable branched triamides include those triamides disclosed in U.S. Pat. No. 6,860,930, which is incorporated herein by reference in its entirety. Any branched triamide disclosed in U.S. Pat. No. 6,860,930 is suitable for use herein. Examples of branched triamides suitable for use herein include those having the formulas:

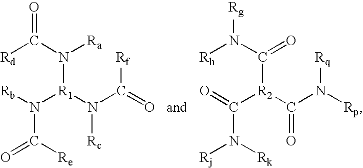

and the like is disclosed in U.S. Pat. No. 6,860,930. In such branched triamides, R₁ and R₂ may be (i) an alkylene group (including linear, branched, saturated, unsaturated, cyclic, substituted, and unsubstituted alkylene groups, and wherein hetero atoms, such as oxygen, nitrogen, sulfur, silicon, phosphorus, and the like either may or may not be present in the alkylene group), having from about 3 carbon atoms to about 200 carbon atoms, such as from about 15 carbon atoms to about 150 carbon atoms or from about 21 carbon atoms to about 100 carbon atoms, (ii) an arylene group (including unsubstituted and substituted arylene groups, and wherein hetero atoms, such as oxygen, nitrogen, sulfur, silicon, phosphorus, and the like either may or may not be present in the arylene group), having from about 6 carbon atoms to about 200 carbon atoms, such as from about 10 carbon atoms to about 150 carbon atoms or from about 14 carbon atoms to about 100 carbon atoms, (iii) an arylalkylene group (including unsubstituted and substituted arylalkylene groups, wherein the alkyl portion of the arylalkylene group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the arylalkylene group), having from about 7 carbon atoms to about 200 carbon atoms, such as from about 8 carbon atoms to about 150 carbon atoms or from about 9 carbon atoms to about 100 carbon atoms, such as benzylene or the like, or (iv) an alkylarylene group (including unsubstituted and substituted alkylarylene groups, wherein the alkyl portion of the alkylarylene group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the alkylarylene group), having from about 7 carbon atoms to about 200 carbon atoms, such as from about 8 carbon atoms to about 150 carbon atoms or from about 9 carbon atoms to about 100 carbon atoms, such as tolylene or the like. Rₐ, R_{b}, R_{c}, R_{g}, Rₕ, Rⱼ, Rₖ, Rₚ and R_{q} may each independently be (i) a hydrogen atom, (ii) an alkyl group (including linear, branched, saturated, unsaturated, cyclic, substituted, and unsubstituted alkyl groups, and wherein hetero atoms, such as oxygen, nitrogen, sulfur, silicon, phosphorus, and the like either may or may not be present in the alkyl group), in embodiments from about 1 carbon atoms to about 200 carbon atoms, such as from about 6 carbon atoms to about 150 carbon atoms or from about 10 carbon atoms to about 100 carbon atoms, (iii) an aryl group (including unsubstituted and substituted aryl groups, and wherein hetero atoms, such as oxygen, nitrogen, sulfur, silicon, phosphorus, and the like either may or may not be present in the aryl group), having from about 6 carbon atoms to about 200 carbon atoms, such as from about 10 carbon atoms to about 150 carbon atoms or from about 14 carbon atoms to about 100 carbon atoms, (iv) an arylalkyl group (including unsubstituted and substituted arylalkyl groups, wherein the alkyl portion of the arylalkyl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the arylalkyl group), having from about 6 carbon atoms to about 200 carbon atoms, such as from about 7 carbon atoms to about 150 carbon atoms or from about 8 carbon atoms to about 100 carbon atoms, or (v) an alkylaryl group (including unsubstituted and substituted alkylaryl groups, wherein the alkyl portion of the alkylaryl group can be linear, branched, saturated, unsaturated, and/or cyclic, and wherein hetero atoms, such as oxygen, nitrogen, sulfur, silicon, phosphorus, and the like either may or may not be present in either or both of the alkyl portion and the aryl portion of the alkylaryl group), having from about 6 carbon atoms to about 200 carbon atoms, such as from about 7 carbon atoms to about 150 carbon atoms or from about 8 carbon atoms to about 100 carbon atoms, such as tolyl or the like. Rd, Re and Rf may each independently be (i) an alkyl group as described above, (ii) an aryl group as described above, (iii) an arylalkyl group as described above, or (iv) an alkylaryl group as described above.

The triamide may be present in the ink in amounts of from about 1 weight percent to about 20 weight percent, such as from about 5 weight percent to about 18 weight percent or from about 8 weight percent to about 13 weight percent of the ink.

Instead of the at least one triamide, or in conjunction with the at least one triamide, the ink may further include at least one rosin ester as a dispersant, such as glyceryl abietate (KE-100®). Without limiting the disclosure herein, it is believed that the rosin esters enhance the dispersing action of the polyalkylene succinimides or the triamide if present. Thus, the rosin esters such as FORAL® 85, a glycerol ester of hydrogenated abietic (rosin) acid (commercially available from Hercules), FORAL® 105, a pentaerythritol ester of hydroabietic (rosin) acid (commercially available from Hercules), CELLOLYN® 21, a hydroabietic (rosin) alcohol ester of phthalic acid (commercially available from Hercules), ARAKAWA KE-311 Resin, a triglyceride of hydrogenated abietic (rosin) acid (commercially available from Arakawa Chemical Industries, Ltd.), may be considered to be a dispersing aid.

In embodiments, the rosin ester may be present in the ink in any desired or effective amount, for example, from about 0.1 weight percent to about 40 weight percent of the ink, such as from about 1 weight percent to about 30 weight percent of the ink or from about 5 weight percent to about 20 weight percent of the ink.

Each dispersant that is present as a component in the total amount of dispersant may be present in the dispersant in equal or different amounts. For example, the polyakylene succinimide may be present in amounts of from about 0.5 weight percent to about 50 weight percent of the total amount of dispersant, such as from about 5 weight percent to about 40 weight percent or from about 20 weight percent to about 30 weight percent of the total amount of dispersant. The triamide, when present in the total amount of dispersant without a rosin ester, may be present in amounts of from about 5 weight percent to about 95 weight percent of the total amount of dispersant, such as from about 20 weight percent to about 60 weight percent or from about 30 weight percent to about 50 weight percent of the total amount of dispersant. And, the rosin ester, when present in the dispersant without a triamide, may be present in amounts of from about 5 weight percent to about 65 weight percent of the total amount of dispersant, such as from about 10 weight percent to about 60 weight percent or from about 15 weight percent to about 50 weight percent of the total amount of dispersant.

When both the at least one triamide and the at least one rosin ester are present in the total amount of the dispersant, the amount of each or polyakylene succinimide, triamide and rosin ester may vary. For example, the amount of polyakylene succinimide present in the total amount of dispersant may be from about 0.5 weight percent to about 50 weight percent of the total amount of dispersant, such as from about 5 weight percent to about 45 weight percent or from about 10 weight percent to about 35 weight percent of the total amount of dispersant. The amount of triamide present in the total amount of dispersant may be from about 1 weight percent to about 80 weight percent of the total amount of dispersant, such as from about 5 weight percent to about 70 weight percent or from about 10 weight percent to about 60 weight percent of the total amount of dispersant. The amount of rosin ester present in present in the total amount of dispersant may be from about 1 weight percent to about 60 weight percent of the total amount of dispersant, such as from about 5 weight percent to about 50 weight percent or from about 10 weight percent to about 35 weight percent of the total amount of dispersant.

In embodiments, the ink may include at least one polyakylene succinimide and at least one triamide as dispersants, at least one polyakylene succinimide and at least one rosin ester as dispersants, or at least one polyakylene succinimide, at least one triamide and at least one rosin ester as dispersants.

Without limiting the disclosure herein, it is theorized that the pigment and the dispersants, such as the polyalkylene succinimide or the triamide, interact by hydrogen bonding and/or acid base interaction. Thus, a strong physical bond is created between the pigment and the dispersants. The polar group of the dispersants interacts with the polar group of the pigment through hydrogen bonding and/or acid base interaction sterically stabilize the pigment particle. The interaction of the dispersants and the pigment also can generate an electrical double layer electrostatically stabilize the pigment particle. The non-polar portions of the dispersants allow the pigment to be evenly dispersed in the non-polar ink vehicle. Although rosin ester may by itself act as a dispersant, rosin esters alone are not effective dispersants. If present, the rosin esters may enhance the interaction between the pigments and the polyalkylene succinimide or the triamide.

The ink of embodiments may further include known additives to take advantage of the known functionality associated with such known additives. Such additives may include, for example, slip and leveling agents, plasticizers, viscosity modifiers, antioxidants, UV absorbers, tackifiers etc.

Plasticizers may be included in the ink, and may include, for example, pentaerythritol tetrabenzoate, commercially available as BENZOFLEX S55 (Velsicol Chemical Corporation), trimethyl titrate, commercially available as CITROFLEX 1 (Monflex Chemical Company), N,N-dimethyl oleamide, commercially available as HALCOMID M-18-OL (C. P. Hall Company), a benzyl phthalate, commercially available as SANTICIZER 278 (Ferro Corporation), and the like, may be added to the ink vehicle, and may constitute from about 1 to 100 percent of the ink vehicle component of the ink. Plasticizers can either function as the ink vehicle or can act as an agent to provide compatibility between the ink propellant, which generally is polar, and the ink vehicle, which generally is non-polar.

The ink may further include an optional viscosity modifier, such as (1) 2-hydroxybenzyl alcohol, (2) 4-hydroxybenzyl alcohol, (3) 4-nitrobenzyl alcohol, (4) 4-hydroxy-3-methoxy benzyl alcohol, (5) 3-methoxy-4-nitrobenzyl alcohol, (6) 2-amino-5-chlorobenzyl alcohol, (7) 2-amino-5-methylbenzyl alcohol, (8) 3-amino-2-methylbenzyl alcohol, (9) 3-amino-4-methyl benzyl alcohol, (10) 2(2-(aminomethyl)phenylthio)benzyl alcohol, (11) 2,4,6-trimethylbenzyl alcohol, (12) 2-amino-2-methyl-1,3-propanediol, (13) 2-amino-1-phenyl-1,3-propanediol, (14) 2,2-dimethyl-1-phenyl-1,3-propanediol, (15) 2-bromo-2-nitro-1,3-propanediol, (16) 3-tert-butylamino-1,2-propanediol, (17) 1,1-diphenyl-1,2-propanediol, (18) 1,4-dibromo-2,3-butanediol, (19) 2,3-dibromo-1,4-butanediol, (20) 2,3-dibromo-2-butene-1,4-diol, (21) 1,1,2-triphenyl-1,2-ethanediol, (22) 2-naphthalenemethanol, (23) 2-methoxy-1-naphthalenemethanol, (24) decafluoro benzhydrol, (25) 2-methylbenzhydrol, (26) 1-benzeneethanol, (27) 4,4′-isopropylidene bis(2-(2,6-dibromo phenoxy)ethanol), (28) 2,2′-(1,4-phenylenedioxy)diethanol, (29) 2,2-bis(hydroxymethyl)-2,2′,2″-nitrilotriethanol, (30) di(trimethylolpropane), (31) 2-amino-3-phenyl-1-propanol, (32) tricyclohexylmethanol, (33) tris(hydroxymethyl) aminomethane succinate, (34) 4,4′-trimethylene bis(1-piperidine ethanol), (35) N-methyl glucamine, (36) xylitol, or mixtures thereof. When present, the viscosity modifier is present in the ink in any effective amount, such as from about 30 percent to about 55 percent by weight of the ink or from about 35 percent to about 50 percent by weight of the ink.

Optional antioxidants in the ink may protect the images from oxidation and also may protect the ink components from oxidation while existing as a heated melt in the ink reservoir. Examples of suitable antioxidants include (1) N,N′-hexamethylene bis(3,5-di-tert-butyl-4-hydroxy hydrocinnamamide) (IRGANOX 1098, available from Ciba-Geigy Corporation), (2) 2,2-bis(4-(2-(3,5-di-tert-butyl-4-hydroxyhydrocinnamoyloxy))ethoxyphenyl) propane (TOPANOL-205, available from ICI America Corporation), (3) tris(4-tert-butyl-3-hydroxy-2,6-dimethyl benzyl) isocyanurate (CYANOX 1790, 41,322-4, LTDP, Aldrich D12,840-6), (4) 2,2′-ethylidene bis(4,6-di-tert-butylphenyl)fluoro phosphonite (ETHANOX-398, available from Ethyl Corporation), (5) tetrakis(2,4-di-tert-butylphenyl)-4,4′-biphenyl diphosphonite (ALDRICH 46,852-5; hardness value 90), (6) pentaerythritol tetrastearate (TCI America #PO739), (7) tributylammonium hypophosphite (Aldrich 42,009-3), (8) 2,6-di-tert-butyl-4-methoxyphenol (Aldrich 25,106-2), (9) 2,4-di-tert-butyl-6-(4-methoxybenzyl)phenol (Aldrich 23,008-1), (10) 4-bromo-2,6-dimethylphenol (Aldrich 34,951-8), (11) 4-bromo-3,5-didimethylphenol (Aldrich B6,420-2), (1) 4-bromo-2-nitrophenol (Aldrich 30,987-7), (13) 4-(diethyl aminomethyl)-2,5-dimethylphenol (Aldrich 14,668-4), (14) 3-dimethylaminophenol (Aldrich D14,400-2), (15) 2-amino-4-tert-amylphenol (Aldrich 41,258-9), (16) 2,6-bis(hydroxymethyl)-p-cresol (Aldrich 22,752-8), (17) 2,2-methylenediphenol (Aldrich B4,680-8), (18) 5-(diethylamino)-2-nitrosophenol (Aldrich 26,951-4), (19) 2,6-dichloro-4-fluorophenol (Aldrich 28,435-1), (20) 2,6-dibromo fluoro phenol (Aldrich 26,003-7), (21) α-trifluoro-o-creso-1 (Aldrich 21,979-7), (22) 2-bromo-4-fluorophenol (Aldrich 30,246-5), (23) 4-fluorophenol (Aldrich F1,320-7), (24) 4-chlorophenyl-2-chloro-1,1,2-tri-fluoroethyl sulfone (Aldrich 13,823-1), (25) 3,4-difluoro phenylacetic acid (Aldrich 29,043-2), (26) 3-fluorophenylacetic acid (Aldrich 24,804-5), (27) 3,5-difluoro phenylacetic acid (Aldrich 29,044-0), (28) 2-fluorophenylacetic acid (Aldrich 20,894-9), (29) 2,5-bis(trifluoromethyl) benzoic acid (Aldrich 32,527-9), (30) ethyl-2-(4-(4-(trifluoromethyl)phenoxy)phenoxy)propionate (Aldrich 25,074-0), (31) tetrakis(2,4-di-tert-butyl phenyl)-4,4′-biphenyl diphosphonite (Aldrich 46,852-5), (32) 4-tert-amyl phenol (Aldrich 15,384-2), (33) 3-(2H-benzotriazol-2-yl)-4-hydroxy phenethylalcohol (Aldrich 43,071-4). NAUGARD 76, NAUGARD 445, NAUGARD 512, AND NAUGARD 524 (manufactured by Uniroyal Chemical Company), and the like, as well as mixtures thereof. The antioxidant, when present, may be present in the ink in any desired or effective amount, such as from about 0.25 percent to about 10 percent by weight of the ink or from about 1 percent to about 5 percent by weight of the ink.

The ink may also optionally contain a UV absorber. The optional UV absorbers primarily protect the generated images from UV degradation. Specific examples of suitable UV absorbers include (1) 2-bromo-2′,4-dimethoxyacetophenone (Aldrich 19,948-6), (2) 2-bromo-2′,5′-dimethoxyacetophenone (Aldrich 10,458-2), (3) 2-bromo-3′-nitroacetophenone (Aldrich 34,421-4), (4) 2-bromo-4′-nitroacetophenone (Aldrich 24,561-5), (5) 3′,5′-diacetoxyacetophenone (Aldrich 11,738-2), (6) 2-phenylsulfonyl acetophenone (Aldrich 34,150-3), (7) 3′-aminoacetophenone (Aldrich 13,935-1), (8) 4′-aminoacetophenone (Aldrich A3,800-2), (9) 1H-benzotriazole-1-acetonitrile (Aldrich 46,752-9), (10) 2-(2H-benzotriazol-2-yl)-4,6-di-tert-pentylphenol (Aldrich 42,274-6), (11) 1,1-(1,2-ethane-diyl)bis(3,3,5,5-tetramethylpiperazinone) (commercially available from Goodrich Chemicals), (12) 2,2,4-trimethyl-1,2 hydroquinoline (commercially available from Mobay Chemical), (13) 2-(4-benzoyl-3-hydroxy phenoxy)ethylacrylate, (14) 2-dodecyl-N-(1,2,2,6,6-pentamethyl-4-piperidinyl)succinimide (commercially available from Aldrich Chemical Co., Milwaukee, Wis.), (15) 2,2,6,6-tetramethyl-4-piperidinyl/β-tetramethyl-3,9-(2,4,8,10-tetraoxo spiro(5,5)-undecane) diethyl-1,2,3,4-butane tetracarboxylate (commercially available from Fairmount), (16) N-(p-ethoxycarbonylphenyl)-N′-ethyl-N′-phenylformadine (commercially available from Givaudan), (17) 6-ethoxy-1,2-dihydro-2,2,4-trimethylquinoline (commercially available from Monsanto Chemicals), (18) 2,4,6-tris-(N-1,4-dimethylpentyl-4-phenylenediamino)-1,3,5-triazine (commercially available from Uniroyal), (19) 2-dodecyl-N-(2,2,6,6-tetrame-thyl-4-piperidinyl)succinimide (commercially available from Aldrich Chemical Co.), (20) N-(1-acetyl-2,2,6,6-tetramethyl-4-piperidinyl)-2-dodecyl succinimide (commercially available from Aldrich Chemical Co.), (21) (1,2,2,6,6-pentamethyl-4-piperidinyl/β-tetramethyl-3,9-(2,4,8,10-tetra oxo-spiro-(5,5)undecane)diethyl)-1,2,3,4-butane tetracarboxylate (commercially available from Fairmount), (22) (2,2,6,6-tetramethyl-4-piperidinyl)-11,2,3,4-butane tetracarboxylate (commercially available from Fairmount), (23) nickel dibutyl dithio carbamate (commercially available as UV-Chek AM-105 from Ferro), (24) 2-amino-2′,5-dichlorobenzophenone (Aldrich 10,515-5), (25) 2′-amino-4′,5′-dimethoxyacetophenone (Aldrich 32,922-3), (26) 2-benzyl-2-(dimethylamino)-4′-morpholino butyrophenone (Aldrich 40,564-7), (27) 4′-benzyloxy-2′-hydroxy-3′-methylacetophenone (Aldrich 29,884-0), (28) 4,4′-bis(diethylamino)benzophenone (Aldrich 16,032-6), (29) 5-chloro-2-hydroxy benzophenone (Aldrich C4,470-2), (30) 4′-piperazinoacetophenone (Aldrich 13,646-8), (31) 4′-piperidinoacetophenone (Aldrich 11,972-5), (32) 2-amino-5-chlorobenzophenone (Aldrich A4,556-4), (33) 3,6-bis(2-methyl-2-morpholinopropionyl)-9-octylcarbazole (Aldrich 46,073-7), and the like, as well as mixtures thereof.

The ink may optionally include a tackifier to increase the adhesion of the ink onto paper. Examples of suitable tackifiers include synthetic polyterpene resins such as NEVTAC® 2300, NEVTAC® 100, and NEVTAC® 80 (commercially available from Neville Chemical Company), WINGTACK® 86, a modified synthetic polyterpene resin (commercially available from Goodyear), VERSAMID® 757, 759, or 744 (commercially available from Henkel) and the like.

When present, the optional additives may each, or in combination, be present in the irk in any desired or effective amount, such as from about 1 percent to about 10 percent by weight of the ink or from about 3 percent to about 5 percent by weight of the ink.

In embodiments, the ink may be prepared by first preparing an ink vehicle in a first container by mixing the components of the ink vehicle at temperatures of from about 90° C. to about 150° C., such as from about 100° C. to about 145° C. or from about 110° C. to about 140° C. The colorant dispersion mixture is prepared by adding the polyalkylene succinimide, and the triamide and/or the rosin ester, and the colorant, in a second container, such as a beaker, flask, etc. The mixture in the second container may then be homogenized at a temperature of from about 90° C. to about 150° C., such as from about 100° C. to about 145° C. or from about 110° C. to about 140° C., for a time of from about 5 minutes to about 2 hours, such as from about 10 minutes to about 1.5 hours or from about 15 minutes to about 1 hour. The melted ink vehicle from the first container may then be added into the homogenized colorant dispersion of the second container. The resulting colored ink, along with other optional ink ingredients, may be further homogenized and melted mixed to form an ink. The resulting ink is then filtered through a filter, such as a glass fiber cartridge-filter, at a temperature of from about 90° C. to about 150° C., such as from about 10° C. to about 145° C. or from about 110° C. to about 140° C. The ink is then cooled to room temperature, approximately 25° C. The resulting colored ink may optionally be high shear mixed when melt-mixed. The colorant dispersion mixture may be optionally pre-treated through an extruder, such as a twin screw extruder, before the melt-mixing and homogenization step in the second container.

The inks disclosed herein may exhibit settling percentage of from about 0 percent to about 8 percent, such as from about 0.1 percent to about 6.5 percent or from about 0.5 percent to about 5 percent. The settling percentage is measured by first aging a sample of the ink in a separatory funnel for approximately 7 days at a temperature of from about 90° C. to about 150° C., such as from about 100° C. to about 145° C. or from about 110° C. to about 140° C. Samples of the ink are then taken from the top layer and bottom layer in the separatory funnel to determine the amount of pigment in each layer as measured by thermogravimetric analysis (TGA). The percent of increase of the pigment in the bottom layer compared to the top layer is the settling percentage.

Printed images may be generated with the ink described herein by incorporating the ink into an ink jet device, for example a thermal ink jet device, an acoustic ink jet device or a piezoelectric ink jet device, heating the ink to an ink jet temperature, and concurrently causing droplets of the molten ink to be ejected in a pattern onto a substrate such as paper or transparency material, which can be recognized as an image. The ink is typically included in the at least one reservoir connected by any suitable feeding device to the ejecting channels and orifices of the ink jet head for ejecting the ink. In the jetting procedure, the ink jet head may be heated, by any suitable method, to the jetting temperature of the inks. The phase change inks are thus transformed from the solid state to a molten state for jetting. “At least one” or “one or more” as used to describe components of the ink jet device, such as the ejecting channels, orifices, etc., refers to from 1 to about 2 million, such as from about 1 to about 40,000 or about 10 to about 20,000 of any such item found in the ink jet device. “At least one” or “one or more” as used to describe other components of the ink jet device such as the ink jet head, reservoir, feeder, etc., refers to from 1 to about 15, such as from 1 to about 8 or from 1 to about 4 of any such component found in the ink jet device.

Phase change ink jet processes are well known and are described, for example, in U.S. Pat. Nos. 4,601,777, 4,251,824, 4,410,899, 4,412,224 and 4,532,530, the disclosures of which are incorporated herein by reference in their entirety.

The inks can also be employed in indirect (offset) printing ink jet applications, wherein when droplets of the melted ink are ejected in an imagewise pattern onto a recording substrate, the recording substrate is an intermediate transfer member and the ink in the imagewise pattern is subsequently transferred from the intermediate transfer member to a final recording substrate, such as paper or transparency.

Embodiments described above will now be further illustrated by way of the following examples.

### EXAMPLES

### Preparation of Pigment Dispersion A

769.19 grams of a triamide powder prepared as disclosed in U.S. Pat. No. 6,860,930 and 230.81 g NIPEX 150 (carbon black pigment) from Degussa Canada, were mixed in a blender for about 30 minutes at room temperature (approximately 25° C.) at about 140 rpm before being added to the twin screw extruder. The mixed carbon black and triamide powder were then processed through the extruder output at about 1 LB/Hr with the process temperature at from about 70° C. to about 90° C. with a screw rotation of about 50 rpm, and a residence time of around 1-2 minutes.

### Preparation of Pigment Dispersion B

Dispersant B was prepared the same as Dispersant A, but the NIPEX 150 (carbon black pigment) was replaced with HOSTAPERM BLUE B4G (a cyan pigment) available from Clariant Corp.

### Ink Example 1

281.57 g of Pigment Dispersant A, 51.46 g of OLOA 11000 (polyalkylene succinimide) from Chevron Oronite, 354.90 g of KEMAMIDE S 180 (a stearamide) from Crompton Corp., 220.49 g of KE100 (a glyceryl abietate) from Arakawa Chemical Industries Ltd. and 5.20 g of NAUGARD N445 (an antioxidant) from Crompton Corp. were melted and mixed in a 4 liter beaker (A) at about 125° C. Beaker (A) was equipped with a heating mantel and a mechanical stirrer. The resulting carbon black dispersion was heated and stirred for about an hour at approximately 125° C. While the carbon black pigment dispersion in beaker (A) was heated and stirred, 1018.87 g of X1197 (a polyethylene wax) from Baker Petrolite, and 68.16 g of urethane resin as described in Example IV of U.S. Pat. No. 6,309,453 was melt-mixed in a 2 liter beaker (B) at a temperature of from about 110° C. to about 125° C. Beaker (B) was equipped with a heating mantel and a mechanical stirrer. The resulting resin dispersion was heated and stirred in beaker (B) for about an hour to make sure that all resins in beaker (B) were fully melt-mixed.

An IKA Ultra Turrax T50 Homogenizer was then used to homogenize the ingredients in beaker (A) for about 30 minutes while the temperature was maintained at about 125° C. The molten resin mixture in beaker (B), which was kept at about 125° C., was then added into the homogenized pigment dispersion in beaker (A). The resulting carbon black ink in beaker (A) was further homogenized for approximately another 30 minutes. After filtering the resulting carbon black ink through a 1 micron and then a 0.45 micron glass fiber cartridge-filter at 120° C., the ink was cooled to room temperature. The resulting ink was then evaluated for stability, settling and jetting performance on a piezo ink jet printer.

### Comparative Ink Example 2

A carbon black ink was prepared as in Ink Example 1 except that OLOA 11000 was not used.

### Ink Example 3

A carbon black ink was prepared similar to Ink Example 1 with higher loading of the succinimide and no glyceryl abietate. Specifically, 281.57 g of Pigment Dispersant A, 64.37 g of OLOA 1000 (polyalkylene succinimide) from Chevron Oronite, 354.90 g of KEMAMIDE S180 (a stearamide) from Crompton Corp., and 5.20 g of NAUGARD N445 (an antioxidant) from Crompton Corp. were melted and mixed in a 4 liter beaker (A) at about 125° C. Beaker (A) was equipped with a heating mantel and a mechanical stirrer. The resulting carbon black dispersion was heated and stirred for about an hour at approximately 125° C. While the carbon black pigment dispersion in beaker (A) was heated and stirred, 1018.87 g of X1197 (a polyethylene wax) from Baker Petrolite, and 68.16 g of urethane resin as disclosed in Example IV of U.S. Pat. No. 6,309,453 was melt-mixed in a 2 liter beaker (B) at a temperature of from about 110° C. to about 125° C. Beaker (B) was equipped with a heating mantel and a mechanical stirrer. The resulting resin dispersion was heated and stirred in beaker (B) for about an hour to make sure that all resins in beaker (B) were fully melt-mixed.

An IKA Ultra Turrax T50 Homogenizer was then used to homogenize the ingredients in beaker (A) for about 30 minutes while the temperature was maintained at about 125° C. The molten resin mixture in beaker (B), which was kept at about 125° C., was then added into the homogenized pigment dispersion in beaker (A). The resulting carbon black ink in beaker (A) was further homogenized for approximately another 30 minutes. After filtering the resulting carbon black ink through a 1 micron and then a 0.45 micron glass fiber cartridge-filter at 120° C., the ink was cooled to room temperature. The resulting ink was then evaluated for stability, settling and jetting performance on a piezo ink jet printer.

### Ink Example 4

A carbon black ink was prepared similar to Ink Example 1 without the triamide resin, and without the extrusion step. Specifically, 57.85 g of OLOA 11000 (polyalkylene succinimide) from Chevron Oronite, 67.47 g Nipex 150 from Degussa Canada, 398.97 g of KEMAMIDE S180 (a stearamide) from Crompton Corp., 247.87 g of KE100 (a glyceryl abietate) from Arakawa Chemical Industries Ltd. and 5.85 g of NAUGARD N445 (an antioxidant) from Crompton Corp. were melted and mixed in a 4 liter beaker (A) at about 125° C. Beaker (A) was equipped with a heating mantel and a mechanical stirrer. The resulting carbon black dispersion was heated and stirred for about an hour at approximately 125° C. While the carbon black pigment dispersion in beaker (A) was heated and stirred, 1145.38 g of X1197 (a polyethylene wax) from Baker Petrolite, and 76.62 g of urethane resin as disclosed in Example IV of U.S. Pat. No. 6,309,453 was melt-mixed in a 2 liter beaker (B) at a temperature of from about 110° C. to about 125° C. Beaker (B) was equipped with a heating mantel and a mechanical stirrer. The resulting resin dispersion was heated and stirred in beaker (B) for about an hour to make sure that all resins in beaker (B) were fully melt-mixed.

An IKA Ultra Turrax T50 Homogenizer was then used to homogenize the ingredients in beaker (A) for about 30 minutes while the temperature was maintained at about 125° C. The molten resin mixture in beaker (B), which was kept at about 125° C., was then added into the homogenized pigment dispersion in beaker (A). The resulting carbon black ink in beaker (A) was further homogenized for approximately another 30 minutes. After filtering the resulting carbon black ink through a 1 micron and then a 0.45 micron glass fiber cartridge-filter at 120° C., the ink was cooled to room temperature. The resulting ink was then evaluated for stability, settling and jetting performance on a piezo ink jet printer.

### Ink Example 5

A cyan pigmented ink was prepared as in Ink Example 1 by replacing the carbon black pigment with the HOSTAPERM B4G (cyan pigment) from Clariant Corp.

### Ink Characterizations

The inks of Examples 1 through 5 were each tested for heat stability as follows. Two 100 gram samples of the ink were taken. One sample of the fresh ink was held in an oven at about 120° C. for about 3 hours. The second sample was aged in an oven at about 120° C. for about 7 days. The filtration slope of the fresh and aged inks to filter through a 0.45 micron glass fiber filter tinder a constant pressure at about 15 psi were measured.

The filtration slope is the total amount of ink filtered over time. The heat stability ratio of the ink is defined as the ratio of the filtration slope of the aged ink to the filtration slope of the fresh ink. A well dispersed ink should have a stability ratio of greater than 0.8.

The inks of Examples 1 through 5 were each tested for settling stability as follows. A 100 gram sample of each ink was kept in a 250 mL separatory funnel aged in an oven at about 120° C. for about 7 days. Ink samples from the top layer and the bottom layer of the funnel were then taken to determine the percentage of pigment at each layer by TGA. The percentage settling of the ink is defined as the percentage increase of the pigment at the bottom layer as compared with the top layer after aged at about 120° C. for about 7 days. A well dispersed ink should have less than 5 percent in settling stability.

Print quality evaluations of the above inks were carried out on a solid ink printer.

Table 1 below provides a comparison between Ink Example 1 and Ink Example 2 with respect to the relevant characterizations as discussed above.

TABLE 1

| | Heat | | |
|---|---|---|---|
| | Stability | PERCENTAGE | PRINT |
| | Ratio | Settling | QUALITY |
| INK EXAMPLE 1 | 1.03 | 1.1% | Excellent, with all |
| | | | jets of the ink jet |
| | | | printer being clear |
| | | | and printing |
| Comparative INK | 0.41 | 16% | Acceptable, some |
| EXAMPLE 2 | | | jets of the ink jet |
| | | | printer were |
| | | | clogged and did not |
| | | | print |
| INK EXAMPLE 3 | 0.98 | 2.0% | Very Good, with all |
| | | | jets of the ink jet |
| | | | printer being clear |
| | | | and printing |
| INK EXAMPLE 4 | 0.80 | 4.9% | Good, with all jets |
| | | | of the ink jet |
| | | | printer being clear |
| | | | and printing |
| INK EXAMPLE 5 | 0.85 | 4.0% | Very Good, with all |
| | | | jets of the ink jet |
| | | | printer being clear |
| | | | and printing |

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A phase change ink comprising an ink vehicle, at least one colorant, at least one polyalkylene succinimide, and at least one triamide and/or at least one rosin ester.

2. The phase change ink according to claim 1, wherein the phase change ink includes both at least one triamide and at least one rosin ester.

3. The phase change ink according to claim 1, wherein the ink vehicle is a polyethylene wax having a weight average molecular weight of from about 350 to about 730.

4. The phase change ink according to claim 1, wherein the colorant is a pigment.

5. The phase change ink according to claim 1, wherein the triamide is a branched triamide.

6. The phase change ink according to claim 6, wherein the branched triamide has a formula of: 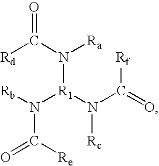
wherein R₁ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms, Rₐ, R_{b} and R_{c} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms, and R_{d}, Rₑ and R_{f} are each independently (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms.

7. The phase change ink according to claim 5, wherein the branched triamide has a formula of: 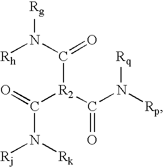
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

8. The phase change ink according to claim 1, wherein the rosin ester is a glyceryl abietate.

9. The phase change ink according to claim 1, wherein the polyalkylene succinimide has a formula of: 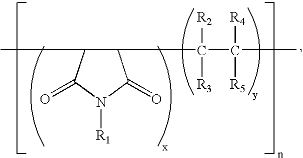
wherein x is an integer representing a number of repeat succinimide units and is from 1 to about 10; y is an integer representing a number of repeat alkylene units and is from 1 to about 10; n is an integer of at least about 2; R₁ is an alkyl group having from about 1 carbon atom to about 100 carbon atoms, an aryl group having from about 4 carbon atoms to about 100 carbon atoms, an arylalkyl group having from about 5 carbon atoms to about 100 carbon atoms, or an alkylaryl group having from about 5 carbon atoms to about 100 carbon atoms; and R₂, R₃, R₄, and R₅ may each independently be a hydrogen atom or an alkyl group having from about 1 carbon atom to about 40 carbon atoms.

10. The phase change ink according to claim 9, wherein the polyalkylene succinimide is a polyisobutylene succinimide.

11. The phase change ink according to claim 1, wherein the polyalkylene succinimide is present in the ink in amounts of from about 0.001 weight percent to about 40 weight percent, and the triamide is present in the ink in amounts of from about 1 weight percent to about 20 weight percent and/or the rosin ester is present in the ink in amounts of from about 0.1 weight percent to about 40 weight percent.

12. A method of forming an ink, comprising:
an extrusion step and a melt-mixing step,
the extrusion step comprising preparing a pigment dispersion mixture in a container by mixing at least one polyalkylene succinimide, and at least one triamide and/or at least one rosin ester, and at least one colorant to form a mixture, introducing the mixture into an extruder, and extruding the mixture, and
the melt-mixing step comprising melt-mixing the extruded mixture together with other ink ingredients including an ink vehicle to form the ink.

13. The method according to claim 12, wherein melt-mixing step further comprises high shear mixing.

14. The method according to claim 12, wherein the at least one polyalkylene succinimide, and the at least one triamide and/or at least one rosin ester, are mixed in the second container.

15. The method according to claim 12, wherein the ink vehicle is a polyethylene wax having a weight average molecular weight of from about 350 to about 730.

16. The method according to claim 12, wherein the colorant is a pigment.

17. The method according to claim 12, wherein the triamide is a branched triamide.

18. The method according to claim 17, wherein the branched triamide has a formula of: 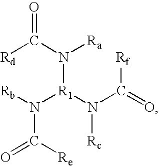
wherein R₁ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms, Rₐ, R_{b} and Rₑ are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms, and R_{d}, Rₑ and R_{f} are each independently (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms.

19. The method according to claim 17, wherein the branched triamide has a formula of: 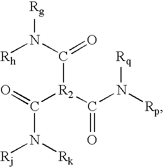
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and k_{g}, Rₕ, Rⱼ, Rₖ, Rₚ, and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

20. The method according to claim 12, wherein the rosin ester is a glyceryl abietate.

21. The method according to claim 12, wherein the polyalkylene succinimide has a formula of: 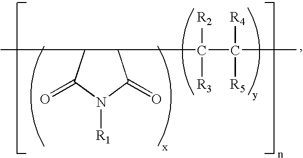
wherein x is an integer representing a number of repeat succinimide units and is from 1 to about 10; y is an integer representing a number of repeat alkylene units and is from 1 to about 10; n is an integer of at least about 2; R₁ is an alkyl group having from about 1 carbon atom to about 100 carbon atoms, an aryl group having from about 4 carbon atoms to about 1100 carbon atoms, an arylalkyl group having from about 5 carbon atoms to about 100 carbon atoms, or an alkylaryl group having from about 5 carbon atoms to about 100 carbon atoms; and R₂, R₃, R₄, and R₅ may each independently be a hydrogen atom or an alkyl group having from about 1 carbon atom to about 40 carbon atoms.

22. The method according to claim 21, wherein the polyalkylene succinimide is a polyisobutylene succinimide.

23. The method according to claim 12, wherein the polyalkylene succinimide is present in the ink in amounts of from about 0.001 weight percent to about 40 weight percent, and the triamide is present in the ink in amounts of from about 1 weight percent to about 20 weight percent and/or the rosin ester is present in the ink in amounts of from about 0.1 weight percent to about 40 weight percent.

24. A ink jet system, comprising:
at least one phase change ink having an ink vehicle, at least one pigment, at least one polyalkylene succinimide, and at least one triamide and/or at least one rosin ester; and
an ink jet device including an ink et head consisting of one or more channels for the at least one phase change ink, and a supply path that supplies the at least one phase change ink to the one or more channels of the ink jet head from one or more reservoirs containing the at least one phase change ink.

25. The ink jet system according to claim 24, wherein the at least the at least one phase change ink includes both at least one triamide and at least one rosin ester

26. The ink jet system according to claim 24, wherein the ink vehicle is a polyethylene wax having a weight average molecular weight of from about 350 to about 730.

27. The ink jet system according to claim 24, wherein different phase change inks of other colors are separately supplied to the ink jet head.
